(19) United States
(12) Patent Application Publication
(10) Pub. No.: US 2016/0170951 A1
(43) Pub. Date: Jun. 16, 2016

(54) Method and a Device Thereof for Automatically Showing and Hiding Web Form Failure Notification Layer

(71) Applicant: Xinyu Xingbang Information Industry Co., Ltd, Xinyu (CN)

(72) Inventors: Xiaohong Yao, Foshan (CN); Zhihong Zhou, Foshan (CN)

(73) Assignee: Xinyu Xingbang Information Industry Co., Ltd

(21) Appl. No.: 14/709,503

(22) Filed: May 12, 2015

(30) Foreign Application Priority Data
Dec. 16, 2014 (CN) 201410782499.6

(51) Int. Cl. G06F 17/24; G06F 17/27; G06F 17/22

(52) U.S. Cl. CPC G06F 17/243; G06F 17/2247; G06F 17/2725

(57) ABSTRACT

The invention discloses a method and a device thereof for automatically showing and hiding web form failure notification layer. The method comprises: loading web forms; entering web forms; judging whether errors occur in the entry; judging whether form element of current entry is covered by the failure notification layer, if so, hiding the failure notification layer and executing the next step; otherwise, returning; judging whether the entry is completed, if so, displaying the failure notification layer covering the form element of current entry; otherwise, executing the next step; judging whether the entry goes on, if so, returning; otherwise, correcting the error and completing the entry; judging whether it passes web form verification, if so, ending this web form entry; otherwise, returning. The invention have the following beneficial effects: the operation is simple and convenient, and the accuracy of form verification result is relatively high.

### CROSS REFERENCE TO RELATED APPLICATIONS

This application claims priority of Chinese patent application No. 201410782499.6 filed on Dec. 16, 2014, the contents of which all hereby incorporated by reference.

### FIELD OF THE INVENTION

The invention relates to the field of web form input verification, and in particular relates to a method and a device thereof for automatically showing and hiding web form failure notification layer.

### BACKGROUND OF THE INVENTION

Generally, the current web form input verification includes two ways: firstly, when designing the form, a corresponding failure notification position is reserved in the case of errors occurring in user form input, which will cause insufficient error position, and other elements in the form are expanded and the form page becomes disordered, and simultaneously the design cost is increased; and secondly, the error information is displayed in a manner of bubble prompting, and the failure notification layer is directly placed on corresponding position of the element (generally above the element), which is easy to cause the phenomenon that original element of the form is covered by the failure notification layer, at this time when the user wants to modify or search the covered element or element content, it is difficult to handle; in conventional solution, a closing button is added above the prompt bubble, the element and the element content can be observed as the prompt information is closed by clicking the closing button, which invisibly increases the operation complexity of the user; and when the user needn't search the covered element, the user will misdeem that the element has passed the verification because the form element verified next has no failure notification information, resulting in poor accuracy of the form verification result.

### SUMMARY OF THE INVENTION

In order to solve the technical problems of the prior art that the operation is complicated and the accuracy of the form verification result is not high, a method and a device thereof for automatically showing and hiding web form failure notification layer are provided, which are simple and convenient to operate and high in accuracy of the form verification result.

The invention, to solve the technical problems, adopts the technical solution as follows: the invention provides a method for automatically showing and hiding web form failure notification layer, wherein, the method comprises the following steps:

A) Loading web forms, wherein the web forms include a plurality of form elements;

B) Entering web forms;

C) Judging whether errors occur in the entry, if so, displaying failure notification layer, and executing step G), otherwise, executing step D);

D) Judging whether form element of current entry is covered by the failure notification layer, if so, hiding the failure notification layer covering the form element of current entry and executing step E), otherwise, returning to step B);

E) Judging whether the entry is completed, if so, displaying the failure notification layer covering the form element of current entry, executing step G), otherwise, executing step F);

F) Judging whether the entry goes on, if so, returning to step B), otherwise, executing step G);

G) Correcting errors and completing the entry;

H) Judging whether it passes web form verification, if so, ending this web form entry, otherwise, returning to step G).

According to the method for automatically showing and hiding web form failure notification layer of the invention, the method, before step A), further comprises a preprocessing step:

A0) Saving position information of the failure notification layer popping up when each element of the web form has input errors in a set.

According to the method for automatically showing and hiding web form failure notification layer of the invention, the position information of the failure notification layer includes information of the position of the topmost end of the failure notification layer in the page, position of the leftmost end of the failure notification layer in the page, and width and height information of the failure notification layer.

According to the method for automatically showing and hiding web form failure notification layer of the invention, the step D) further comprises:

D1) Calculating position information of the layer of form element of the current entry;

D2) Comparing the position information of the layer of form element of the current entry with position information of the failure notification layer stored in the set one by one;

D3) Judging whether the area with overlapped coordinates exists, if so, confirming that the form element of the current entry is covered and hiding the failure notification layer covering the form element of current entry, otherwise, returning to step B).

According to the method for automatically showing and hiding web form failure notification layer of the invention, the position information of the layer of the form element of the current entry includes information of the position of the topmost end of the layer of the form element of the current entry in the page, position of the leftmost end of the layer of the form element of the current entry in the page, and width and height information of the layer of the form element of the current entry.

The invention further relates to a device for implementing the method for automatically showing and hiding web form failure notification layer, wherein, the device comprises:

A loading unit: for loading web forms, wherein the web forms include a plurality of form elements;

An entry unit: for entering web forms;

An error judging unit: for judging whether errors occur in the entry;

A covering unit: for judging whether form element of current entry is covered by the failure notification layer, if so, hiding the failure notification layer covering the form element of current entry, otherwise, returning;

An entry completing unit: for judging whether the entry is completed, if so, displaying the failure notification layer covering the form element of current entry, otherwise, further judging whether the entry goes on;

An entry judging unit: for judging whether the entry goes on;

A correcting unit: for correcting errors and completing the entry;

A passing unit: for judging whether it passes web form verification, if so, ending this web form entry, otherwise, returning.

According to the device for implementing the method for automatically showing and hiding web form failure notification layer, the device further comprises:

A preprocessing unit: for saving position information of the failure notification layer popping up when each element of the web form has input errors in a set.

According to the device for implementing the method for automatically showing and hiding web form failure notification layer, the position information of the failure notification layer includes information of the position of the topmost end of the failure notification layer in the page, position of the leftmost end of the failure notification layer in the page, and width and height information of the failure notification layer.

According to the device for implementing the method for automatically showing and hiding web form failure notification layer, the covering unit further comprises:

A calculating module: for calculating the position information of the layer of form element of current entry;

A comparing module: for comparing the position information of the layer of form element of current entry with the position information of the failure notification layer stored in the set one by one;

An overlap judging module: for judging whether the area with overlapped coordinates exists, if so, confirming that the form element of the current entry is covered and hiding the failure notification layer covering the form element of current entry, otherwise, returning.

According to the device for implementing the method for automatically showing and hiding web form failure notification layer of the invention, the position information of the layer of the form element of the current entry includes information of the position of the topmost end of the layer of the form element of the current entry in the page, position of the leftmost end of the layer of the form element of the current entry in the page, and width and height information of the layer of the form element of the current entry.

The method and the device thereof for automatically showing and hiding web form failure notification layer have the following beneficial effects: as the failure notification layer will be displayed in the case of errors occurring in form entry, the failure notification layer covering the form element of the current entry is automatically hidden when the form element of the current entry is covered by the failure notification layer, so as to facilitate user entry; after completing the entry, the failure notification layer is automatically displayed; therefore, complicated operation of the user is avoided, the operation is simple and convenient, and the accuracy of form verification result is relatively high.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention; for those skilled in the art, on the precondition of not making creative work, other attached drawings can be obtained based on the attached drawings below.

FIG. 1 is a flow chart of the method in an embodiment of the method and the device thereof for automatically showing and hiding web form failure notification layer;

FIG. 2 is a specific flow chart of judging whether the form element of current entry is covered by the failure notification layer according to the embodiment;

FIG. 3 is a functional block diagram of the method according to the embodiment;

FIG. 4 is a structural schematic diagram of the device according to the embodiment.

### DESCRIPTION OF THE PREFERRED EMBODIMENTS

In order to make apparent the objects, technical details and advantages of the embodiments of the invention, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

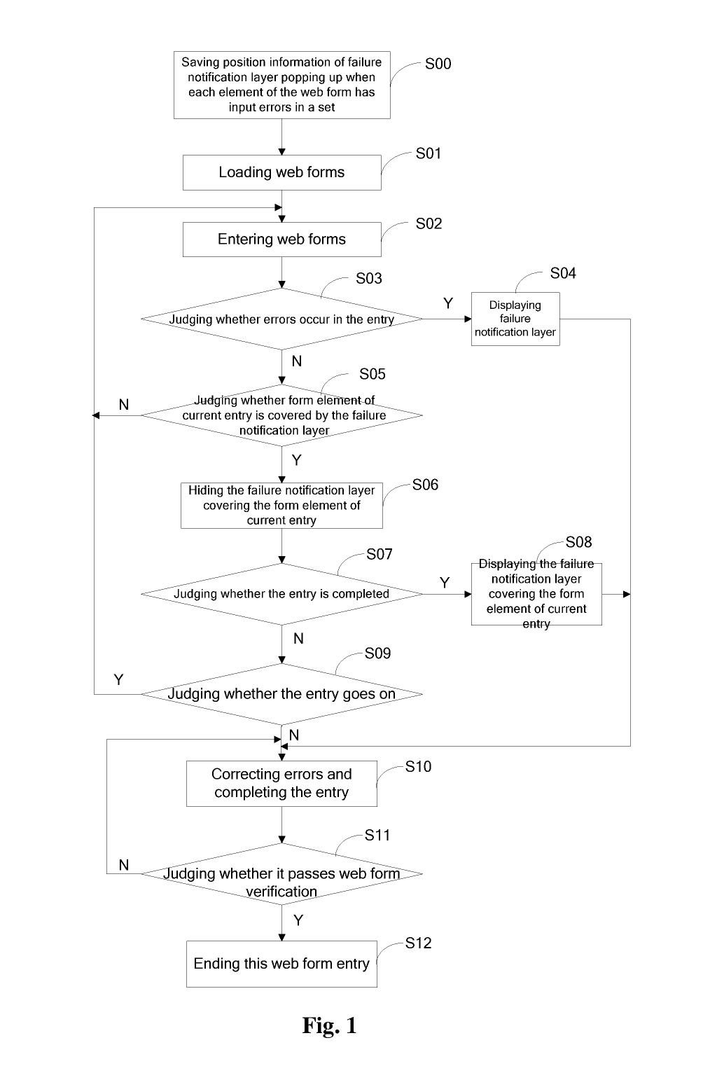

According to the embodiment of the method and the device thereof for automatically showing and hiding web form failure notification layer of the invention, the flow chart of the method and the device thereof for automatically showing and hiding web form failure notification layer is shown as FIG. 1. As shown in FIG. 1, the method for automatically showing and hiding web form failure notification layer comprises the following steps:

Step S01: loading web forms: in this step, it loads web forms, wherein the web form includes a plurality of form elements.

Step S02: entering web forms: in this step, it carries out web form entry.

Step S03: judging whether errors occur in the entry: in this step, it judges whether errors occur in the entry, if so, executes step S04, otherwise, executes step S05.

Step S04: displaying failure notification layer: if the judgment result of the step S03 is positive, this step is executed. In this step, it displays failure notification layer and failure notification information is displayed by the failure notification layer to the user. After this step, step S10 is executed.

Step S05: judging whether form element of current entry is covered by the failure notification layer: if the judgment result of the step S03 is negative this step is executed. In this step, it judges whether form element of current entry is covered by the failure notification layer, if so, executes step S06, otherwise, executes step S02.

Step S06: hiding the failure notification layer covering the form element of current entry; if the judgment result of the step S05 is positive, this step is executed. In this step, it hides the failure notification layer covering the form element of current entry. After this step, step S07 is executed.

Step S07: judging whether the entry is completed: in this step, it judges whether the entry is completed, if so, executes step S08, otherwise, executes step S09.

Step S08: displaying the failure notification layer covering the form element of current entry: if the judgment result of the step S07 is positive, this step is executed. In this step, it displays the failure notification layer covering the form element of current entry. After this step, step S10 is executed.

Step S09: judging whether the entry goes on: if the judgment result of the step S07 is negative, this step is executed. In this step, it judges whether the entry goes on, if so, returns to step S02, otherwise, executes step S10.

Step S10: correcting errors and completing the entry: in this step, it corrects error and completes entry. After this step, step S11 is executed.

Step S11: judging whether it passes web form verification: in this step, it judges whether it passes web form verification, if so, returns to step S12, otherwise, executes step S10.

Step S12: ending this web form entry: if the judgment result of the step S11 is positive, this step is executed. In this step, it ends this web form entry. As the failure notification layer will be displayed in the case of errors occurring in form entry, the failure notification layer covering the form element of the current entry is automatically hidden when the form element of the current entry is covered by the failure notification layer, so as to facilitate user entry; after completing the entry, the failure notification layer is automatically displayed; therefore, complicated operation of the user is avoided, the operation is simple and convenient, and the accuracy of form verification result is relatively high. The method, depending on concern point of the user, can automatically hide the failure notification layer, so as to avoid influence on web form input of the user and improve user experiencing.

It is worth mentioning that, according to the embodiment, the method further comprises a preprocessing step before the step S01:

Step S00: saving position information of the failure notification layer popping up when each element of the web form has input errors in a set: in this step, it saves position information of the failure notification layer popping up when each element of the web form has input errors in a set. The position information includes information of the position of the topmost end of the failure notification layer in the page, position of the leftmost end of the failure notification layer in the page, and width and height information of the failure notification layer, so as to facilitate following comparison. Certainly, this step is not necessary if the position information of each failure notification layer is saved in advance. This step is implemented under a circumstance that the position information of each failure notification layer is not saved in advance.

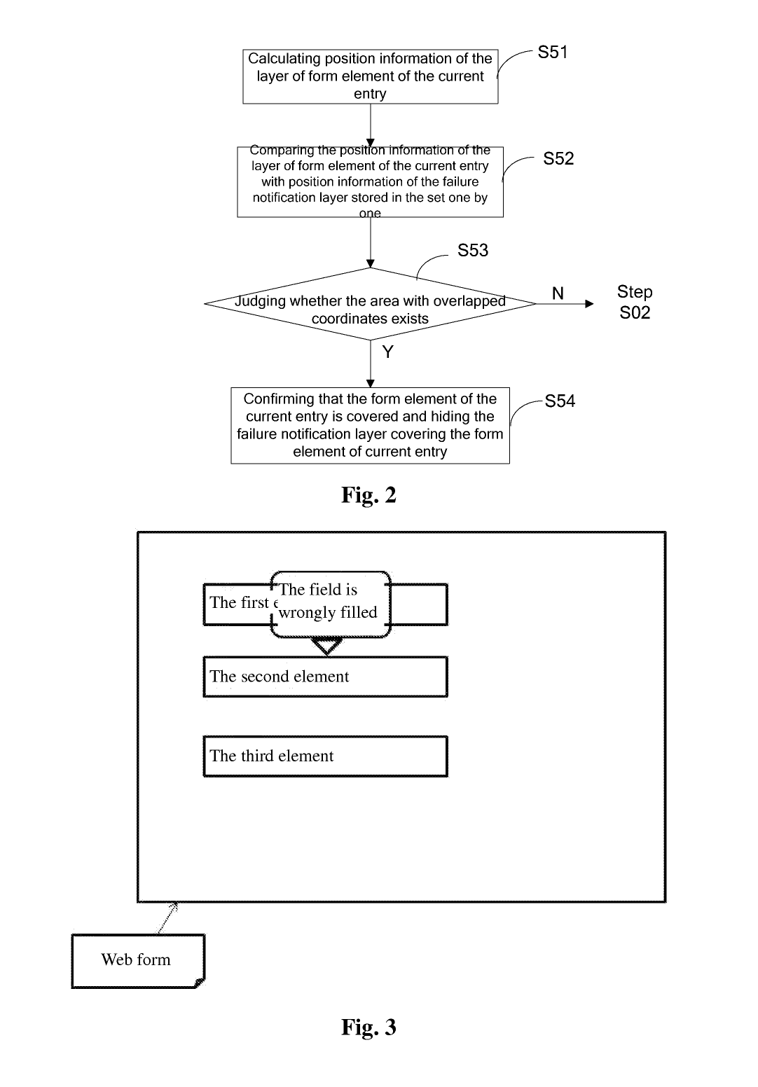

According to the embodiment, the step S05 and step S06 can be further refined, and the flow chart after refining is shown as FIG. 2. As shown in FIG. 2, the step S05 and step S06 further comprise:

Step S51: calculating position information of the layer of form element of the current entry: in this step, it calculates position information of the layer of form element of the current entry.

Step S52: comparing the position information of the layer of form element of the current entry with position information of the failure notification layer stored in the set one by one: in this step, it compares the position information of the layer of form element of the current entry with the position information of the failure notification layer stored in the set one by one, mainly compares coordinate information. The position information of the layer of the form element of the current entry includes information of the position of the topmost end of the layer of the form element of the current entry in the page, position of the leftmost end of the layer of the form element of the current entry in the page, and width and height information of the layer of the form element of the current entry.

Step S53: judging whether the area with overlapped coordinates exists: in this step, it judges whether the area with overlapped coordinates exists, namely judges whether there is the area that the coordinates of the layer of the form element of current entry is overlapped with the coordinates of the failure notification layer stored in the set, if so, executes step S54, otherwise, returns to step S02.

Step S54: confirming that the form element of the current entry is covered and hiding the failure notification layer covering the form element of current entry: if the judgment result of the step S53 is positive, this step is executed. In this step, it confirms that the form element of the current entry is covered and hides the failure notification layer covering the form element of current entry, so as to facilitate the user to continuously operate the form element of the current entry.

FIG. 3 is a functional block diagram of the method for automatically showing and hiding web form failure notification layer according to the embodiment. When the second element of the web forms is filled, the failure notification layer props up in the case of input errors; the first element will be covered by the notification of the failure notification layer, and the position information of the failure notification layer (namely failure notification box) is saved; when the user wants to modify the first element, the position information of the first element is calculated and position information of the failure notification layer gathered in the set is iterated through, and the failure notification layer is automatically hidden if the coordinate of any failure notification layer in the set is overlapped with the coordinate of the first element, so as to avoid an operation of closing the failure notification layer, reduce the complexity of operation and enhance user experiencing.

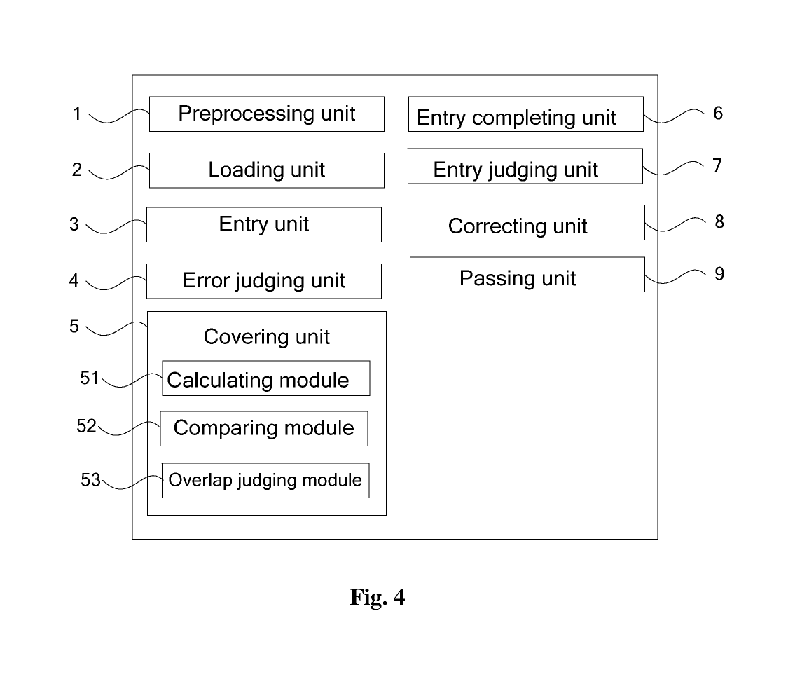

According to the embodiment, the invention further relates to a device for implementing the method for automatically showing and hiding web form failure notification layer, and the structural schematic diagram is shown as FIG. 4. As shown in FIG. 4, the device comprises a loading unit 2, an entry unit 3, an error judging unit 4, a covering unit 5, an entry completing unit 6, an entry judging unit 7, a correcting unit 8 and a passing unit 9, wherein the loading unit 2 is used for loading web forms, wherein the web forms include a plurality of form elements; the entry unit 3 is used for entering web forms; the error judging unit 4 is used for judging whether errors occur in the entry, if so, displaying failure notification layer; the covering unit 5 is used for judging whether form element of current entry is covered by the failure notification layer, if so, hiding the failure notification layer covering the form element of current entry, otherwise, returning; the entry completing unit 6 is used for judging whether the entry is completed, if so, displaying the failure notification layer covering the form element of current entry, otherwise, further judging whether the entry goes on; the entry judging unit 7 is used for judging whether the entry goes on; the correcting unit 8 is used for correcting errors and completing the entry; the passing unit 9 is used for judging whether it passes web form verification, if so, ending this web form entry, otherwise, returning. As the failure notification layer will be displayed in the case of errors occurring in form entry, the failure notification layer covering the form element of the current entry is automatically hidden when the form element of the current entry is covered by the failure notification layer, so as to facilitate user entry; after completing the entry, the failure notification layer is automatically displayed; therefore, complicated operation of the user is avoided, the operation is simple and convenient, and the accuracy of form verification result is relatively high. The method, depending on concern point of the user, can automatically hide the failure notification layer, so as to avoid influence on web form input of the user and improve user experiencing.

According to the embodiment, the device further comprises a preprocessing unit 1, for saving position information of the failure notification layer popping up when each element of the web form has input errors in a set. The position information of the failure notification layer includes information of the position of the topmost end of the failure notification layer in the page, position of the leftmost end of the failure notification layer in the page, and width and height information of the failure notification layer. Certainly, the preprocessing unit 1 is not necessary if the position information of each failure notification layer is saved in advance, and the preprocessing unit 1 is required under a circumstance that the position information of each failure notification layer is not saved in advance.

According to the embodiment, the covering unit 5 further comprises a calculating module 51, a comparing module 52 and an overlap judging module 53, wherein the calculating module 51 is used for calculating the position information of the layer of form element of current entry; the comparing module 52 is used for comparing the position information of the layer of form element of current entry with the position information of the failure notification layer stored in the set one by one; the overlap judging module 53 is used for judging whether the area with overlapped coordinates exists, if so, confirming that the form element of the current entry is covered and hiding the failure notification layer covering the form element of current entry, otherwise, returning. The position information of the layer of the form element of the current entry includes information of the position of the topmost end of the layer of the form element of the current entry in the page, position of the leftmost end of the layer of the form element of the current entry in the page, and width and height information of the layer of the form element of the current entry.

In conclusion, according to the embodiment, when the user fills form information, the forms will display corresponding failure notification layer in case of errors in information inputted by user, and the form element and content in the form element may be covered by the popped layer; when the user wants to concern the covered form element and content, the invention will automatically hide the failure notification layer of the form element; specifically, in the case of input errors of the user, the failure notification layer of form element inputted by the user props up, the position information of the failure notification layer in the page is recorded and the position information is saved in a set; when the user moves mouse or inputs cursor onto the layer of other elements of the forms, the position information of the layer is calculated; the set covering the position information of all failure notification layers is iterated through, the failure notification layers are compared, the failure notification layer is hidden if there are areas having coordinates overlapped, and the failure notification layer is displayed if there is no coordinate overlapping, thus completing automatic hiding and displaying of the failure notification layer. According to the invention, the failure notification layer can be automatically hidden or displayed depending on concern point (the position of mouse) of the user, so as to avoid user misunderstanding and make the user possibly search the covered element, thus greatly facilitating user operation.

The foregoing embodiments are merely exemplary embodiments of the invention, and not intended to define the scope of the invention, and any modification, equivalent replacement, improvement and the like within the spirit and the principle of the invention shall be included within the protection scope of the invention.

What is claimed is:

1. A method for automatically showing and hiding web form failure notification layer, wherein, the method comprises the following steps:
A) Loading web forms, wherein the web forms include a plurality of form elements;
B) Entering web forms;
C) Judging whether errors occur in the entry, if so, displaying failure notification layer, and executing step G); otherwise, executing step D);
D) Judging whether form element of current entry is covered by the failure notification layer, if so, hiding the failure notification layer covering the form element of current entry and executing step E), otherwise, returning to step B);
E) Judging whether the entry is completed, if so, displaying the failure notification layer covering the form element of current entry, executing step G), otherwise, executing step F);
F) Judging whether the entry goes on, if so, returning to step B), otherwise, executing step G);
G) Correcting errors and completing the entry;
H) Judging whether it passes web form verification, if so, ending this web form entry, otherwise, returning to step G).

2. The method for automatically showing and hiding web form failure notification layer according to claim 1, wherein, before step A), the method further comprises a preprocessing step:
A0) Saving position information of the failure notification layer popping up when each element of the web form has input errors in a set.

3. The method for automatically showing and hiding web form failure notification layer according to claim 2, wherein, the position information of the failure notification layer includes information of the position of the topmost end of the failure notification layer in the page, position of the leftmost end of the failure notification layer in the page, and width and height information of the failure notification layer.

4. The method for automatically showing and hiding web form failure notification layer according to claim 3, wherein, the step D) further comprises:
D1) Calculating position information of the layer of form element of the current entry;
D2) Comparing the position information of the layer of form element of the current entry with the position information of the failure notification layer stored in the set one by one;
D3) Judging whether the area with overlapped coordinates exists, if so, confirming that the form element of the current entry is covered and hiding the failure notification layer covering the form element of current entry, otherwise, returning to step B).

5. The method for automatically showing and hiding web form failure notification layer according to claim 4, wherein, the position information of the layer of the form element of the current entry includes information of the position of the topmost end of the layer of the form element of the current entry in the page, position of the leftmost end of the layer of the form element of the current entry in the page, and width and height information of the layer of the form element of the current entry.

6. A device for implementing the method for automatically showing and hiding web form failure notification layer according to claim 1, wherein, the device comprises:
A loading unit: for loading web forms, wherein the web forms include a plurality of form elements;
An entry unit: for entering web forms;
An error judging unit: for judging whether errors occur in the entry;
A covering unit: for judging whether form element of current entry is covered by the failure notification layer, if so, hiding the failure notification layer covering the form element of current entry, otherwise, returning;
An entry completing unit: for judging whether the entry is completed, if so, displaying the failure notification layer covering the form element of current entry, otherwise, further judging whether the entry goes on;
An entry judging unit: for judging whether the entry goes on;
A correcting unit: for correcting errors and completing the entry;
A passing unit: for judging whether it passes web form verification, if so, ending this web form entry, otherwise, returning.

7. The device for implementing the method for automatically showing and hiding web form failure notification layer according to claim 6, wherein, the device further comprises:
A preprocessing unit: for saving position information of the failure notification layer popping up when each element of the web form has input errors in a set.

8. The device for implementing the method for automatically showing and hiding web form failure notification layer according to claim 7, wherein, the position information of the failure notification layer includes information of the position of the topmost end of the failure notification layer in the page, position of the leftmost end of the failure notification layer in the page, and width and height information of the failure notification layer.

9. The device for implementing the method for automatically showing and hiding web form failure notification layer according to claim 8, wherein, the covering unit further comprises:
A calculating module: for calculating the position information of the layer of form element of current entry;
A comparing module: for comparing the position information of the layer of form element of current entry with the position information of the failure notification layer stored in the set one by one;
An overlap judging module: for judging whether the area with overlapped coordinates exists, if so, confirming that the form element of the current entry is covered and hiding the failure notification layer covering the form element of current entry, otherwise, returning.

10. The device for implementing the method for automatically showing and hiding web form failure notification layer according to claim 9, wherein, the position information of the layer of the form element of the current entry includes information of the position of the topmost end of the layer of the form element of the current entry in the page, position of the leftmost end of the layer of the form element of the current entry in the page, and width and height information of the layer of the form element of the current entry.
